(19) United States
(12) Patent Application Publication
(10) Pub. No.: US 2020/0307915 A1
(43) Pub. Date: Oct. 1, 2020

(54) Debris Chute

(71) Applicant: Andrea STODULKA, Hume (AU)

(72) Inventor: Andrea STODULKA, Hume (AU)

(21) Appl. No.: 16/638,803

(22) PCT Filed: Aug. 13, 2018
(86) PCT No.: PCT/AU2018/050853

§ 371 Date: Feb. 13, 2020

(30) Foreign Application Priority Data
Aug. 14, 2017 (AU) 2017903252

(51) Int. Cl. B65G 11/02; B65G 11/18; E04G 5/00

(52) U.S. Cl. CPC B65G 11/026; E04G 5/00; B65G 11/186

(57) ABSTRACT

A gravity type debris chute formed by hanging a plurality of corner panels on corners of a structure having horizontal elements, a plurality of side panels and a door panel on the structure with horizontal structural elements so as to form a passage for debris to pass through, wherein each of the said corner panels is folded in the middle so as to form two symmetrical sides, the top of each of said corner panels folded to form a lip or a u fold so as to hang from a structural member, each of said side panels folded at the top to form a u fold or a lip capable of hanging from a horizontal structural member.

### INTRODUCTION

The present invention relates to gravity type conveyors or chutes which are often used for dropping building and demolition waste from any floor of the building in a controlled manner. The object of the present invention is to provide a system for debris removal process at construction sites more effective and convenient.

Prior art entails nesting performed prefabricated cylindrical tubes, or chutes constructed on site from ply or other materials. Problems that often arise include upstream openings are at the wrong height, side openings at lower levels are at inconvenient heights and that side openings and the openings at the upper end are too small a diameter to be useful. Thus it is an object of this invention to provide prefabricated material chute sections which can be united to form a single gravity chute having a plurality of openings from one or more sides through which operators can drop material into the chute at any level with an overall opening as large as possible. A related problem is the use of the chute at different levels at the same time whereby debris may bounce through a lower vertical opening. It is an object of this invention to install a warning system indicating the operation of any one side opening.

This invention comprises a debris chute in the shape of a rectangular chute section made up of 8 interchangeable individual panels nested with other sections to form a debris chute fitted with side openings as required for accepting and transporting material conveyed by the chute.

The side opening consists of a panel that is hinged at the either the bottom of the panel, top of the panel or on the top and bottom so as to open the panel sideways so as to allow rotation.

The panels of the present invention can be supported on to an existing structure such as scaffolding eliminating the need for a separate structure. Each of the panels of the present invention can be attached to an existing structural support frame such as scaffolding by brackets or by other attaching means.

The prefabricated chute sections of the present invention are interchangeable, easily transported and easily erected and disassembled on site.

It is another object of this invention to provide sections having side openings covered by doors.

### SUMMARY OF THE INVENTION

According to the principles of the invention a series of eight individuals panels make up an octagonal conveyor chute section such that the eight panels are connected to each other to form an enclosed shaft or passage in which individual panels are supported onto a structure such as existing scaffolding or a frame.

The individual plates are hung on horizontal members of the existing structure by hooks attached to the individual panels or a inverted u shaped channel at the top edge of each panel formed by folding the panel. The panels are located in such a way as to overlap with each other and also the panels immediately below to prevent any leakage of debris through corners and provide a smooth passage for falling debris material. Up to four of the central panels on all four sides can be replaced by rotatable/hinged doors at levels determined by the horizontal ties of the external support structure. The corner panels are made slightly wider than the diameter of the largest vertical support member.

The angle of the door panels can be adjusted to suit the method of disposing the material and or to deflect and eliminate the possibility material bouncing out of the chute.

Main advantages of the present invention are its simplicity, ability to install or hang on an existing structure such as a scaffolding and the ability to dismantle and transport easily. In addition, the panels of the present invention can be used on a structure of any size by hanging overlapping side panels and door panels.

The panels can be made out of any rigid material such as steel, plastic, Aluminium or even timber (plywood).

### DETAIL DESCRIPTION OF THE INVENTION

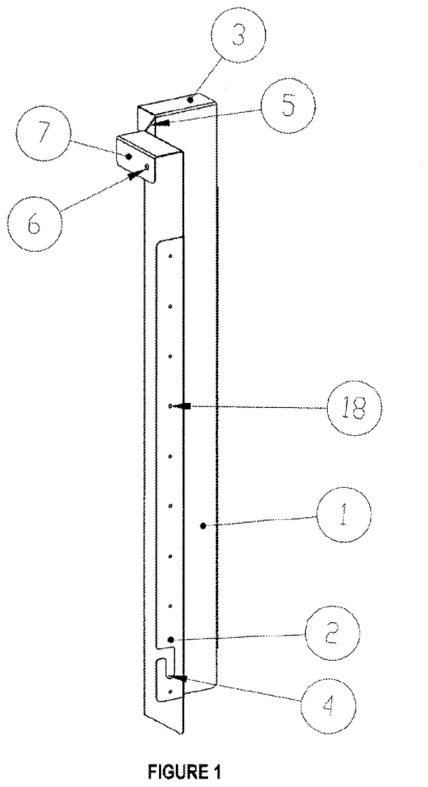

The FIG. 1 as shown represents a corner panel of the present invention.

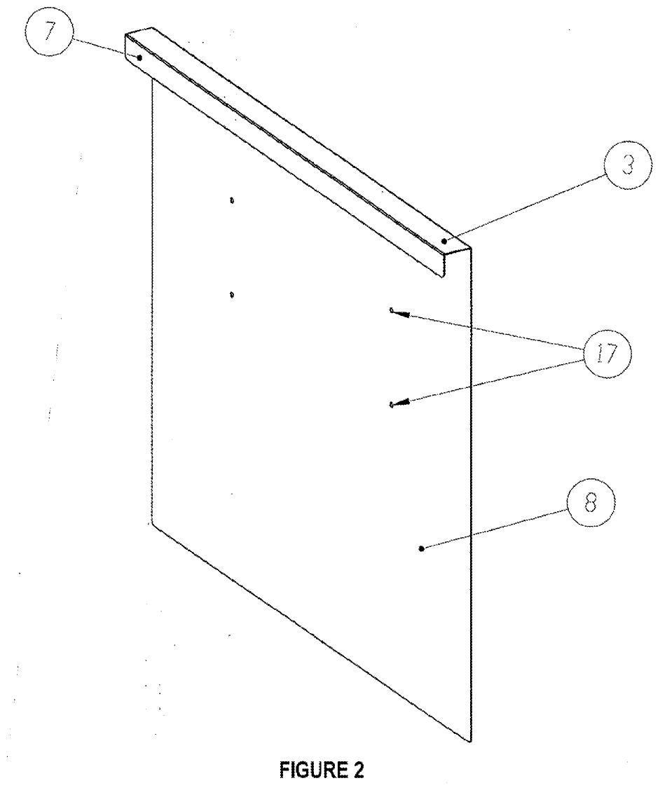

The FIG. 2 as shown represents a side panel of the present invention.

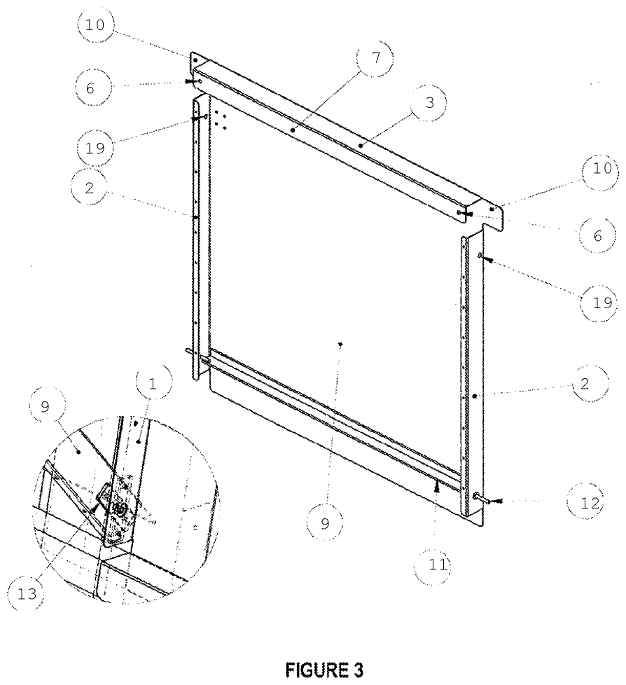

FIG. 3 as shown represents a door panel showing additional supporting channels on either side.

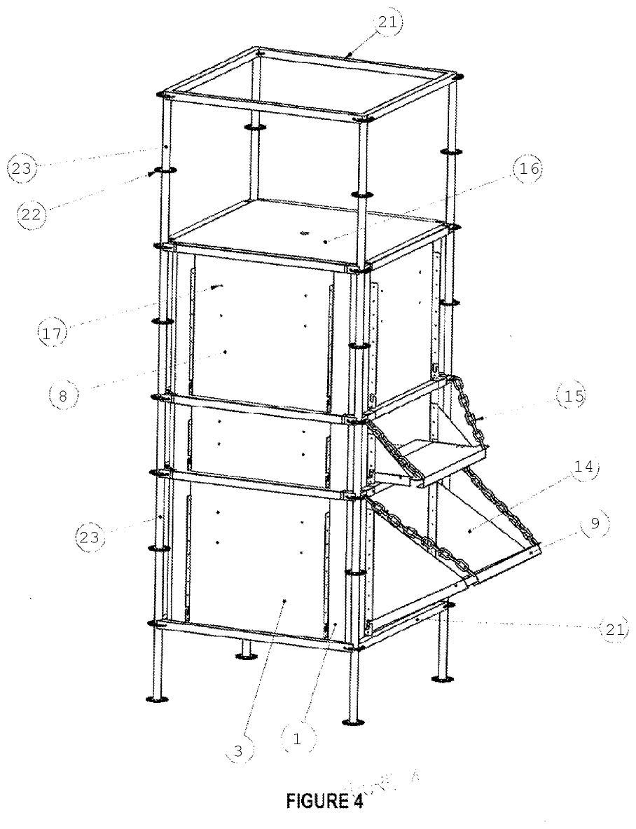

FIG. 4 represents a schematic chute of the present invention in fully assembled.

The invention is described below in detail with reference to the drawings.

The corner panel as shown in FIG. 1. As shown in FIG. 1, the corner panel is made by folding one piece in the middle as to form two symmetrical sides. The angle between the sides can be anything from about 90 degrees to 120 degrees.

The top of each side of the corner panel is folded at the top to form a lip or a u-fold (3,7) which can be used to hang the corner panel on an existing structural frame. The middle fold (5) is created to prevent any interference with an vertical support of an existing structural frame such as scaffolding.

FIG. 2 of the present invention illustrates a side panel of the present invention. It is folded at the top to form a U-fold or lip (3,7) which can be used for hanging on a horizontal element of an existing structural frame such as scaffolding.

FIG. 3 is an illustration of the door panel of the present invention. Similar to side panels of the present invention, the door panel is folded at the top end to form a u-fold or a lip (3,7) which can be used for hanging from a horizontal member of an existing structural frame such as a scaffolding. In addition, it has a striker (12), stiffener (11) with a bar and striker support, hinge (13) and a stop (10) to prevent the door panel from falling in. Item 19 is a spring-loaded catch.

FIG. 4 shows the present invention is use with side panels and door panels hung on horizontal members of an existing support structure such as a scaffolding. The corner panels (1) are attached at the four corners around the vertical frame (23) as shown. The side panels (8) are hung from the horizontal elements (21) on three sides as shown. On the third side, the door panel (9) is hinged at the bottom and chains (15) from the horizontal member immediately above. Flexible bellows (13) prevents any material falling through sides when the doors are open. A dust cover (16) can be positioned at any point of the vertical structure to prevent escape of any dust.

1. A gravity type debris chute formed by hanging a plurality of corner panels on corners of a structure having horizontal elements, a plurality of side panels and a door panel on the structure with horizontal structural elements so as to form a passage for debris to pass through, wherein each of the said corner panels is folded in the middle so as to form two symmetrical sides, the top of each of said corner panels folded to form a lip or a u fold so as to hang from a structural member, each of said side panels folded at the top to form a u fold or a lip capable of hanging from a horizontal structural member, the said door panel folded at the top end to form a u fold or a lip for hanging from a horizontal structural element, the said door panel further comprising a striker and a stiffener to prevent the door panel falling into the said passage through which debris passes through.

2. A debris chute as defined in claim 1 in which the corner plate is made of a single piece of metal plate.

3. A debris chute as defined in claim 2 where in the set of structural elements comprises an existing set of scaffolding members.

4. A debris chute as defined in claim 3 wherein the existing scaffolding members are placed horizontally to form an octagon for hanging four corner plates, three side plate and one door plate to form a debris chute passage with an octagonal cross section to form an enclosed passage or shaft for debris to pass through.

5. A debris chute as defined in claim 4, where a series of eight individuals panels make up an octagonal conveyor chute section such that the eight panels are connected to each other to form an enclosed shaft or passage in which individual panels are supported onto a structure such as existing scaffolding or a frame.

6. A debris chute as defined in claim 5, wherein a plurality of corner plates, side plates and door plates are hung from the horizontal members of an existing scaffolding structure and nested above each other to form a passage or shaft for debris to pass through.

7. A debris chute as defined in claim 6, wherein the angle between the two sides of the corner plate is anything from 90 degrees to 120 degrees.

8. A debris chute as defined in claim 7 wherein the middle fold of the corner plate in the corner plate is created in such a way as to prevent any interference with any vertical structural members of an existing scaffolding.

9. A debris chute as defined claim 8 wherein the four corner plates are attached to four corners of a horizontal structure.

10. A debris chute as defined in claim 9, wherein door panels are hung at different heights of a structure, corresponding to different floor levels of a building.

11. A debris chute as defined in claim 10 where the door panels are rotatable or hinged to a horizontal structural member.

12. A debris chute as defined in claim 10 where the door panel is hinged to a bottom horizontal structural member.

13. A debris panel of claim 10 where the door panel is hinged to a top horizontal structural member.

14. A debris chute of claim 10 where the door panel is supported by chains linked to a top horizontal structural member.

15. A debris chute as defined in claim 10 where a dust cover is positioned to prevent escape of any dust.

16. A debris chute as defined in claim 10 where it includes a warning system to indicate if any of the door panels are open.

17. A debris chute as defined in claim 10, where panels are made of any rigid material such as steel, plastic, aluminum or plywood.
